(19) United States
(12) Patent Application Publication
(10) Pub. No.: US 2003/0215126 A1
(43) Pub. Date: Nov. 20, 2003

(54) Apparatus and method for examining function of convergence adjustment

(75) Inventor: Jae-Keun Park, Suwon-si (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/330,244

(22) Filed: Dec. 30, 2002

(30) Foreign Application Priority Data
May 17, 2002 (KR) 2002-27344

(51) Int. Cl. G06K 9/00

(52) U.S. Cl. 382/141

(57) ABSTRACT

An apparatus and a method for examining whether an automatic convergence adjustment function of a projection television (PJTV) set is well performed or not. The provided examination apparatus includes a camera for photographing images displayed on a screen of a PJTV set; an image grabber for capturing the images photographed by the camera; a unit for generating a control command to be applied to the PJTV set; a memory for storing the images captured by the image grabber; and a control unit for applying a convergence adjustment command to the PJTV set, capturing by using the image grabber a start image before a convergence adjustment process of the PJTV set and a result image after the convergence adjustment process, storing the images in the memory, and determining whether the convergence adjustment process is well performed by comparing and analyzing the start image and the result image stored in the memory.

This application claims the priority of Korean Patent Application No. 2002-27344, filed May 17, 2002, which is incorporated herein in its entirety by reference.

### BACKGROUND OF THE INVENTION

1. Field of the Invention

The present invention relates to factory automation equipment, and more particularly, to an apparatus and a method for examining whether a convergence adjustment function of a projection television (PJTV) set is well performed or not.

2. Description of the Related Art

A PJTV set uses three cathode ray tubes (CRTs) to form images on a screen. Electronic beams generated by the CRTs are deflected by deflection coils and projected to a screen to display images. Here, in order to clearly display the images, the electronic beams have to be respectively projected to precise locations.

The adjustment process of electronic beams generated by the CRTs in order to project the electronic beams to precise locations on a screen is referred to as a convergence adjustment process.

A PJTV set includes a convergence adjustment function of user mode so that a user may perform a convergence adjustment process. Here, the convergence adjustment function of user mode is provided to adjust mismatch of convergence, which is dependent upon the spatial location of a user, i.e., the utilization location of a PJTV set. In addition, the manufacturing process of a PJTV set includes an examination process for determining whether the convergence adjustment function of user mode is well performed or not.

However, in a conventional examination process, an operator examines with the naked eye whether a convergence adjustment function of a PJTV set is well performed or not.

In such a manual examination method, since the operation is overly simple, human errors cannot be prevented, and since examination periods are not uniformly determined, improvement of productivity via time analysis cannot be attained. In addition, the manual examination method requires an adequate space in a factory in order to examine the convergence adjustment function.

Furthermore, the conventional examination process, dependent upon manual and numerical measurements, requires expensive examination equipment so that the examination and PJTV set manufacturing cost increases.

### SUMMARY OF THE INVENTION

To solve the above-described problems, it is an objective of the present invention to provide an examination apparatus for automatically examining a function of a projection television (PJTV) set.

It is another objective of the present invention to provide an examination method for automatically examining a function of a PJTV set.

To accomplish the above objective of the present invention, an examination apparatus for a convergence adjustment function comprises a camera for photographing images displayed on a screen of a PJTV set; an image grabber for capturing the images photographed by the camera; a unit for generating a control command to be applied to the PJTV set; a memory for storing the images captured by the image grabber; and a control unit for applying a convergence adjustment command to the PJTV set, capturing by using the image grabber an image before a convergence adjustment process of the PJTV set, i.e., a start image, and an image after the convergence adjustment process, i.e., a result image, storing the images in the memory, and determining whether the convergence adjustment process is well performed by comparing and analyzing the start image and the result image stored in the memory.

The unit for generating a control command to be applied to the PJTV set may comprise an infrared ray (IR) transmitter. However, those of ordinary skill in the art will appreciate various means of generating a control command including, but not limited to, a keyboard, optical devices, or other analog or digital devices.

To accomplish another objective of the present invention, an examination method for a convergence adjustment function of a PJTV set comprises generating and applying a control command letting the PJTV set perform a convergence adjustment process of user mode to the PJTV set; photographing images displayed on a screen of the PJTV set by using a camera during the convergence adjustment process of the PJTV set; capturing images photographed by the camera including images at least before and after the convergence adjustment process; storing the captured images in a memory; and comparing a start image captured before the convergence adjustment process with a result image captured after the convergence adjustment process, both images being stored in the memory, when the convergence adjustment process is completed in the PJTV set to determine whether the convergence adjustment process is well performed or not.

### BRIEF DESCRIPTION OF THE DRAWINGS

The above objectives and advantages of the present invention will become more apparent by describing in detail preferred embodiments thereof with reference to the attached drawings in which:

FIG. 1 is a diagram illustrating a conventional method for examining a function of a projection television (PJTV) set;

FIG. 2 is a diagram illustrating a convergence adjustment process performed in a PJTV set;

FIG. 3 is a block diagram illustrating the constitution of an examination apparatus according to the present invention;

FIG. 4 is a diagram illustrating an examination process by using the examination apparatus of FIG. 3;

FIG. 5 is a block diagram illustrating a process of determining whether a convergence adjustment process is well performed or not in an examination apparatus according to the present invention;

FIG. 6 is a flowchart illustrating a method for examining a convergence adjustment function according to the present invention; and

FIG. 7 illustrates an examination apparatus according to an embodiment of the present invention.

### DETAILED DESCRIPTION OF THE INVENTION

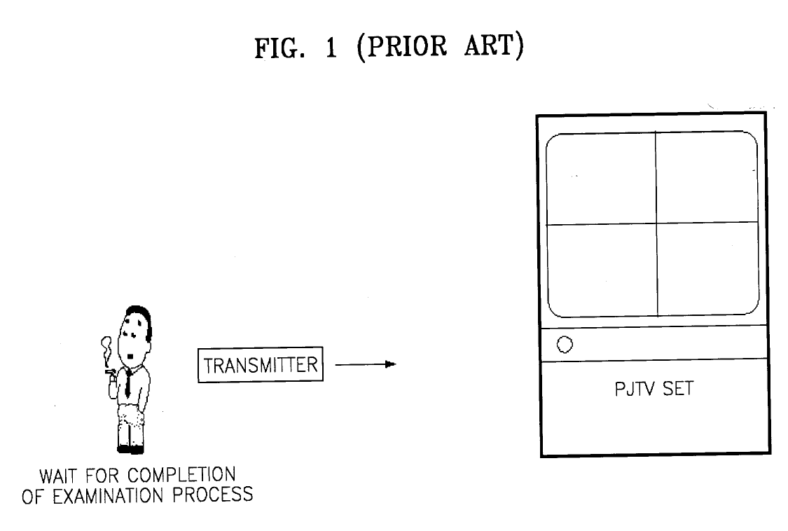

FIG. 1 is a diagram illustrating a conventional method for examining a convergence adjustment function of a projection television (PJTV) set. With reference to FIG. 1, an operator applies a control command through a transmitter instructing a PJTV set to perform a convergence adjustment process. Here, when the PJTV set receives the convergence control command, a program installed in the PJTV set operates a convergence adjustment process.

When the PJTV set has completed the convergence adjustment process, the operator examines with the naked eye whether the convergence adjustment process is well performed.

In the case where the convergence adjustment process is performed well, the operator transfers the PJTV set to a following process. In the other case, the operator transfers the PJTV set to an error control process. Here, while the PJTV set performs the convergence adjustment process, the operator simply waits for the completion of the convergence adjustment process.

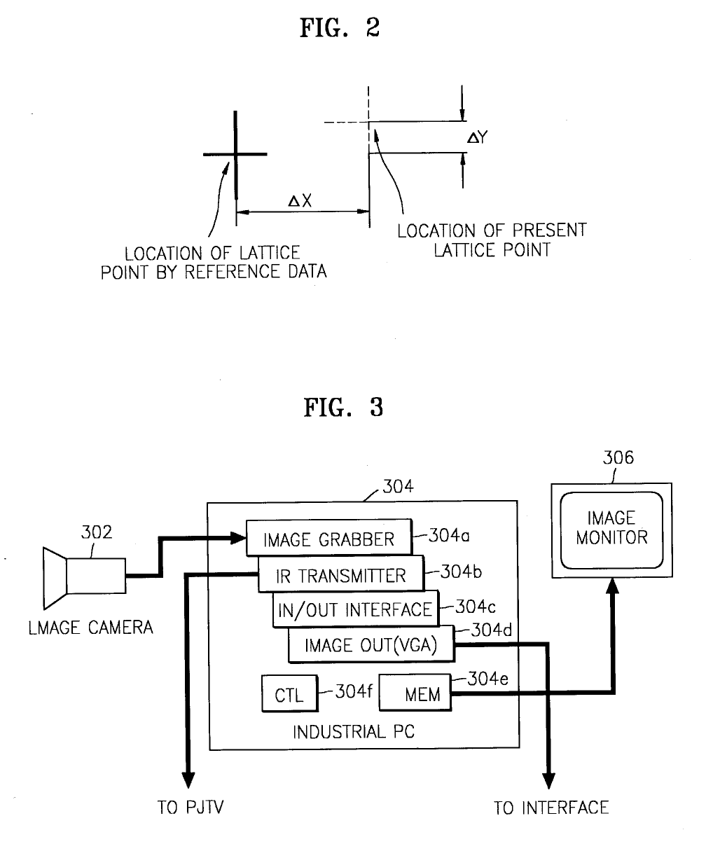

FIG. 2 is a diagram illustrating a convergence adjustment process performed in a PJTV set. Here, the convergence adjustment process is divided into a convergence adjustment process of factory mode and a convergence adjustment process of user mode.

The convergence adjustment process of factory mode, which is performed in a factory by using a separate convergence adjustment apparatus, adjusts a basic convergence by adjusting the locations of deflection coils.

Here, the basic convergence is referred to as a convergence under a condition omitting the utilization environment of a PJTV set. For example, PJTV sets are used in different geometrical locations so that the PJTV sets receive different amount of geomagnetic fields according to his location. Accordingly, the mismatch of a convergence due to a geomagnetic field is dependent upon the utilization location of a PJTV set so that the mismatch of the convergence cannot be adjusted in a manufacture process.

The convergence adjustment process of user mode minimizes effects of the utilization environment of a PJTV set, for example, adjusts the mismatch of a convergence caused by the effects of a geomagnetic field.

The convergence adjustment process of user mode is performed by comparing a reference data prepared in a basic convergence adjustment process with a present data prepared in using a PJTV set, and minimizing the difference between the reference data and the present data.

Generally, cross hatch patterns or cross patterns, which are black and white patterns having lattices arranged in left, right, vertical, and horizontal directions with a predetermined interval therebetween, are used for a convergence adjustment process. Here, the lattices are displayed in white while other areas except for the lattices are displayed in black.

In the last step of the convergence adjustment process of factory mode, predetermined cross patterns are displayed with reference to a predetermined location on a screen to detect the locations of pixels for lattice points and store information on the detected locations in the analyzed PJTV set. Here, data having the location information, i.e., the location information on the lattice points, are referred to as reference data.

Since a PJTV set uses deflection coils, the PJTV set cannot help to avoid the effects of geomagnetic fields. Accordingly, a convergence adjustment process of user mode for minimizing the effects of the geomagnetic fields is performed as follows.

Predetermined cross hatch patterns are displayed with reference to a predetermined location on a screen. Here, the cross hatch patterns and the locations thereof are the same as those used in a convergence adjustment process of factory mode. Accordingly, if a convergence mismatch has not occurred, the locations of lattice points in a user mode are identical with the locations of lattice points in a factory mode. However, if the convergence mismatch has occurred by the effects of geomagnetic fields, the locations of the lattice points in the user mode are mismatched by the amount induced by the effects of the geomagnetic fields so that deviations occur.

Thereafter, the locations of the lattice points are detected on the screen. Here, four sensors are installed in a PJTV set to detect the locations of the lattice points.

The difference between the locations of the lattice points detected by the sensors and the locations of the lattice points in the reference data, i.e., the deviation (ΔX, ΔY), is detected.

The convergence is adjusted in a direction for eliminating the deviation. For example, the convergence is adjusted by adjusting the offset of a driving current applied to deflection electrodes.

Thereafter, the locations of the lattice points are detected and compared again with the reference data. The above processes are repeated until the deviation is reduced less than a tolerance range.

FIG. 3 is a block diagram illustrating the constitution of an examination apparatus according to the present invention. As described in FIG. 3, an examination apparatus according to the present invention includes a camera 302 for photographing images displayed on the screen of a PJTV set, a computer 304 as an examination device for analyzing the images photographed by the camera 302 to determine whether a convergence adjustment process is well performed or to perform the convergence adjustment process, and a monitor 306 for displaying the procedure of the determination process. Although the examination device can be embodied in various pieces of equipment, the examination device is embodied in a personal computer in the present invention.

The computer 304 includes an image grabber 304a for capturing the images photographed by the camera 302, an infrared ray (IR) transmitter 304b for generating and transmitting a control command to a PJTV set, an input/output (I/O) interface 304c for interfacing with other devices, an image output unit 304d for outputting images, a memory 304e for storing an examination program and the captured images, and a control unit 304f for controlling each components to perform an examination process.

Here, the camera 302 photographs the images displayed on the screen of the PJTV set, and the image grabber 304a captures a start image and a result image, which are images before and after a convergence adjustment process of user mode, respectively. Since the procedure for the convergence adjustment process of user mode is set in the PJTV set, the times for capturing the start image and the result image can be easily determined. Otherwise, the PJTV set may transmit the start and end times of a convergence adjustment process of user mode to the computer 304 so that the computer 304 can determine capture timings with reference to the start and end times.

The captured images are stored in the memory 304e and compared with each other to determine whether the convergence adjustment process is well performed or not.

The IR transmitter 304b generates a control command instructing the PJTV set to perform the convergence adjustment process of user mode. Here, the control command used in the IR transmitter 304b is formed in a factory mode type, which performs the same function as the control command of a user mode type while being formed in a different type from the control command of the user mode type. When a remote control command is applied to adjust the functions of a PJTV set in a factory, particularly the functions of the user mode, control commands generated in other steps might be mixed with the control command of a present step. Therefore, a control command free from interference has to be used. To this end, the control command of the factory mode type is used.

The I/O interface 304c is used to interface with other devices. The PJTV set to be examined is transferred by a conveyor, which stops at a location for performing an examination process and moves after the examination process is finished.

The examination apparatus includes location sensors for recognizing that the PJTV set arrives at a desired location and transferring a signal about the arrival of the PJTV set to the computer 304. The I/O interface 304c interfaces with the location sensors.

The image output unit 304d generates image signals for displaying the procedure of the examination process and the image signals are displayed on the monitor 306.

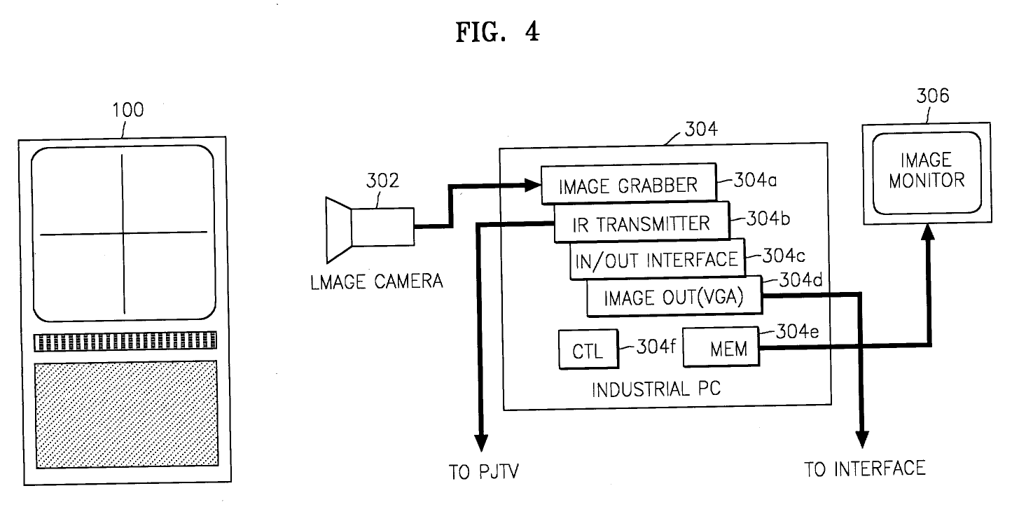

FIG. 4 is a diagram illustrating an examination process using the examination apparatus of FIG. 3.

When a PJTV set 100 to be examined is introduced into an examination process, location sensors (not shown) recognize the PJTV set 100 and apply a signal to a computer 304. An I/O interface 304c of the computer 304 recognizes the signal and starts an examination process.

When the examination process is started, an IR transmitter 304b generates a control command instructing the PJTV set 100 to perform a convergence adjustment process of user mode and applies the control command to the PJTV set 100. The PJTV set 100 analyzes the control command to perform the convergence adjustment process and display the result of the convergence adjustment process. More specifically, when the convergence adjustment process is performed well, adjusted cross hatch patterns are displayed. In the other case, a white pattern is displayed.

Here, if the mismatched amounts of the lattice points are out of a predetermined range after performing the convergence adjustment process for a predetermined period, it is determined that the convergence adjustment process is performed badly.

During the convergence adjustment process, an image grabber 304a captures a start image before the convergence adjustment process and a result image after the convergence adjustment process, and a memory 304e stores the images. Here, the result image is one of a cross hatch pattern image and a white pattern image.

When the convergence adjustment process of user mode is completed in the PJTV set, a control unit 304f compares the start image with the resultant image, which are stored in the memory 304e, to determine whether the convergence adjustment process is well performed or not. The result of the determination is displayed on a monitor 306.

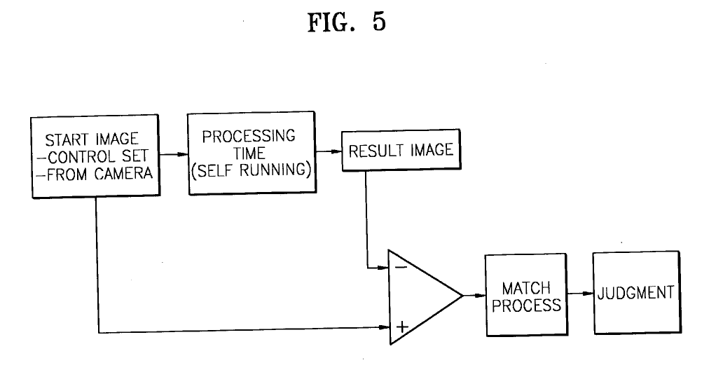

FIG. 5 is a block diagram illustrating a process for determining whether a convergence adjustment process is well performed or not in an examination apparatus according to the present invention. Referring to FIG. 5, a start image and a result image are compared and a similarity of the images is calculated. Thereafter, it is determined whether the convergence adjustment process is well performed or not by analyzing the calculated similarity.

More specifically, a control unit 304f determines a similarity between the start image and the result image stored in the memory 304e and determines whether the convergence adjustment process is well performed or not according to the similarity. For example, a PJTV set displays cross hatch patterns in the start step of the convergence adjustment process and displays one of the adjusted cross hatch patterns and a white pattern in the end step of the convergence adjustment process.

When the convergence adjustment process is performed well, the PJTV set displays the adjusted cross hatch patterns. In the other case, the PJTV set displays the white pattern.

Accordingly, if the convergence adjustment process is performed well in the PJTV set, both the start image and the result image display the cross hatch patterns. Therefore, there is a high similarity between the start image and the result image.

On the contrary, if the performance of the convergence adjustment process is bad, the start image displays the cross hatch patterns but the result image displays the white pattern. Therefore, there is a very low similarity between the start image and the result image.

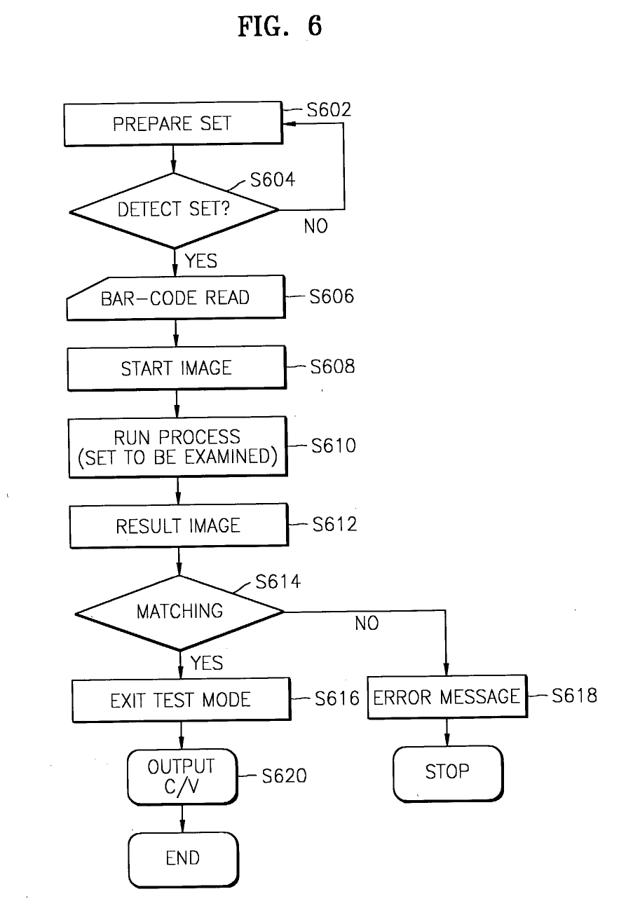

FIG. 6 is a flowchart illustrating a method for examining a convergence adjustment function according to the present invention.

The location of a PJTV set to be examined is detected to determine whether the PJTV set is located at an appropriate examination location in steps 602 and 604. Here, location sensors generate signals reporting that the PJTV set to be examined is located at the appropriate examination location, and a computer 304 recognizes the signals in order to start an examination process.

The computer 304 reads a barcode of the PJTV set to be examined in step 606. An IR transmitter 304b transmits a control command to the PJTV set to be examined so as to operate a convergence adjustment process of user mode. The PJTV set analyzes the received control command to perform the convergence adjustment process of user mode.

A start image is captured in step 608. Here, an image grabber 304a captures the image in the start step of the convergence adjustment process of user mode. In this case, the PJTV set displays predetermined cross hatch patterns on a predetermined location of a screen.

The convergence adjustment process in the PJTV set is completed in step 610.

A result image is captured in step 612.

Here, the PJTV set displays adjusted cross hatch patterns or a white pattern. In other words, the PJTV set outputs different patterns according to the result of the convergence adjustment process so that an examination apparatus easily determines the result of the examination process.

The start image and the result image are compared to determine whether the convergence adjustment process is well performed or not in step 614.

If it is determined that the convergence adjustment process is performed well in step 614, the examination process is ended in step 616.

In the other case, a message reporting that the convergence adjustment process is performed badly is output in step 618.

The message is displayed on a monitor 306 so that following processes are performed according to the message. The above-described method is simpler than the conventional method using manual and numerical measurements so that the cost for the convergence adjustment process is low.

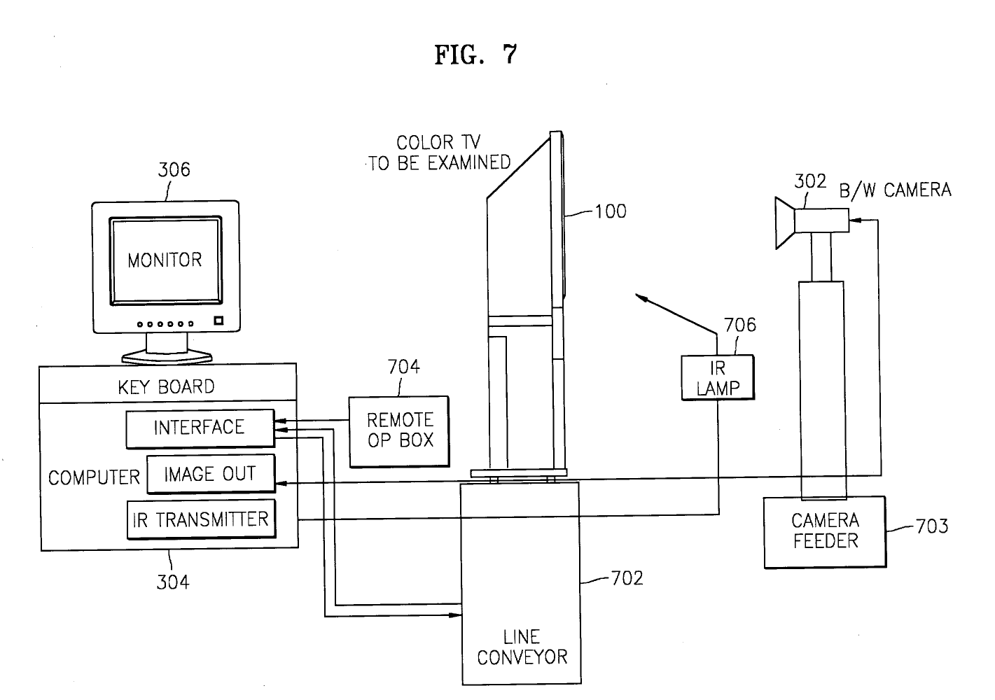

FIG. 7 illustrates an examination apparatus according to an embodiment of the present invention.

Referring to FIG. 7, an examination apparatus includes a computer 304 for controlling an examination process, a monitor 306 for displaying an examination procedure and the result of the examination process, a PJTV set 100 to be examined, a line conveyor 702 for transferring the PJTV set 100, a remote control box 704 having location sensors for detecting the location of the PJTV set 100, an IR lamp 706 for generating an IR signal corresponding to a control command according to the control of an IR transmitter in the computer 304, a camera 302, and a camera feeder 708 for controlling the location of the camera 302.

The remote control box 704 includes the location sensors for detecting the location of the PJTV set 100. When the PJTV set 100 arrives at an examination location by the line conveyor 702, the location sensors transfer signals reporting the arrival of the PJTV set 100 at the examination location to the computer 304.

When the signals generated by the locations sensors are applied to the computer 304, the computer 304 stops the line conveyor 702 to start the examination process. When the examination process is completed, the computer 304 makes the conveyor 702 move again.

An examination apparatus for convergence adjustment process according to the present invention simplifies an examination process and the examination result of the convergence adjustment process is displayed on a monitor. In addition, following processes are controlled by using the examination result. Therefore, the cost for the examination process is low.

Although a convergence adjustment process of user mode is described in the above description, the scope of the present invention is not limited to the convergence adjustment process of user mode. It is well known to those skilled in the art that the components of the present invention may be transformed or applied to similar components and functions.

It is noted that the present invention is not limited to the preferred embodiments described above, and it is apparent that variations and modifications by those skilled in the art can be effected within the spirit and scope of the present invention defined in the appended claims.

According to the above-described examination apparatus, the examination process of a convergence adjustment function of a PJTV set can be automated.

In addition, according to the above-described examination apparatus, human errors caused by simple operation can be prevented and examination periods are determined so that productivity can be analyzed and improved.

What is claimed is:

1. An examination apparatus for a convergence adjustment function, the examination apparatus comprising:
a camera for photographing images displayed on a screen of a projection television (PJTV) set;
an image grabber for capturing the images photographed by the camera;
a unit for generating a control command;
a memory for storing the images captured by the image grabber; and
a control unit for applying a convergence adjustment command to the PJTV set in response to the control command, capturing by using the image grabber a start image before a convergence adjustment process of the PJTV set and a result image after the convergence adjustment process, storing the start and result images in the memory, and determining whether the convergence adjustment process is well performed by comparing and analyzing the start image and the result image stored in the memory.

2. The examination apparatus for a convergence adjustment function of claim 1, further comprising location sensors for generating signals reporting that the PJTV set is located at an appropriate examination location, the signals being sent to the control unit, wherein the control unit determines a start of an examination process according to the signal applied from the location sensors.

3. The examination apparatus for a convergence adjustment function of claim 2, further comprising:
a line conveyor for transferring the PJTV set; and
an input/output (I/O) interface for controlling a movement of the line conveyor according to a control of the control unit.

4. The examination apparatus for a convergence adjustment function of claim 1, further comprising an image output unit for generating an image signal to display a procedure of an examination process.

5. An examination apparatus for a convergence adjustment function, the examination apparatus comprising:
a camera for photographing images displayed on a screen of a PJTV set; and
a computer for analyzing the image photographed by the camera to determine whether a convergence adjustment process is well performed or not or to perform control operations for the convergence adjustment process,
wherein the computer includes:
an image grabber for capturing the images photographed by the camera;
a unit for generating a control command;
a memory for storing a program for an examination process and the images captured by the image grabber; and
a control unit for applying a convergence adjustment command to the PJTV set in response to the control command, capturing by using the image grabber a start image before a convergence adjustment process of the PJTV set and a result image after the convergence adjustment process, storing the start and result images in the memory, and determining whether the convergence adjustment process is well performed by comparing and analyzing the start image and the result image stored in the memory.

6. The examination apparatus for a convergence adjustment function of claim 5, further comprising location sensors for generating signals reporting that the PJTV set is located at an appropriate examination location to the control unit, wherein the control unit determines a start of the examination process according to the signal applied from the location sensors.

7. The examination apparatus for a convergence adjustment function of claim 5, further comprising:
a line conveyor for transferring the PJTV set; and
an input/output (I/O) interface for controlling a movement of the line conveyor according to a control of the control unit.

8. The examination apparatus for a convergence adjustment function of claim 5, further comprising an image output unit for generating an image signal to display a procedure of the examination process.

9. The examination apparatus for a convergence adjustment function of claim 5, wherein the PJTV set outputs different patterns according to a result of the convergence adjustment process, so that the control unit easily determines whether the convergence adjustment process is well performed or not.

10. An examination method for a convergence adjustment process where an image having lattice points for a convergence examination process is displayed at a predetermined location on a screen, the locations of the lattice points of the displayed image and locations of reference lattice points are compared, and a beam scanning unit is adjusted to reduce a deviation between the locations of the lattice points, the examination method comprising:
(a) capturing a start image displayed before the convergence adjustment process, and storing the start image in a memory;
(b) capturing a result image displayed after the convergence adjustment process, and storing the result image in the memory; and
(c) comparing the start image with the result image stored in the memory to examine whether the convergence adjustment process is well performed or not.

11. The examination method for a convergence adjustment process of claim 10, wherein (c) further includes:
(c-1) comparing the start image with the result image stored in the memory to detect deviations for each lattice point;
(c-2) analyzing a distribution of detected deviations; and
(c-3) determining whether the convergent adjustment process is well performed or not according to a predetermined deviation range denoting that the convergence adjustment process is well performed.

12. The examination method for a convergence adjustment process of claim 10, wherein a PJTV set outputs different patterns according to results of the convergence adjustment process, so that it is easily determined whether the convergence adjustment process is well performed or not.

13. An examination method for a convergence adjustment function of a PJTV set, the examination method comprising:
generating and applying a control command letting the PJTV set perform a convergence adjustment process of user mode to the PJTV set;
photographing images displayed on a screen of the PJTV set by using a camera during the convergence adjustment process of the PJTV set;
capturing images photographed by the camera including at least a start image photographed before the convergence adjustment process and a result image photographed after the convergence adjustment process;
storing the captured images in a memory; and
comparing the start image with the result image, both the start image and the result image being stored in the memory, when the convergence adjustment process is completed in the PJTV set to determine whether the convergence adjustment process is well performed or not.

14. The examination method for a convergence adjustment function of a PJTV set of claim 13, further comprising deciding a start of an examination process according to a signal which reports that the PJTV set to be examined is located at an appropriate examination location.

15. The examination method for a convergence adjustment function of a PJTV set of claim 13, further comprising stopping a line conveyor, which transfers the PJTV set, when a signal reporting that the PJTV set to be examined is located at an appropriate examination location, and moving the line conveyor when an examination process is completed.

16. The examination method for a convergence adjustment function of a PJTV set of claim 13, further comprising generating an image signal to display a procedure of an examination process.

17. The examination method for a convergence adjustment function of a PJTV set of claim 13, wherein the PJTV set outputs different patterns according to results of the convergence adjustment process, so that the control unit easily determines whether the convergence adjustment process is well performed or not.

18. The examination apparatus for a convergence adjustment function of claim 1, wherein the unit for generating a control command to be applied to the PJTV set is an infrared ray (IR) transmitter.

19. The examination apparatus for a convergence adjustment function of claim 5, wherein the unit for generating a control command to be applied to the PJTV set is an infrared ray (IR) transmitter.
